(19) United States
(12) Patent Application Publication
(10) Pub. No.: US 2026/0038017 A1
(43) Pub. Date: Feb. 5, 2026

(54) SERVER DEVICE FOR SUPPORTING INPUT OF PRODUCT INFORMATION, INPUT SUPPORT METHOD, AND RECORDING MEDIUM

(71) Applicant: Rakuten Group, Inc., Tokyo (JP)

(72) Inventor: Yumehito NAKAYAMA, Tokyo (JP)

(73) Assignee: Rakuten Group, Inc., Tokyo (JP)

(21) Appl. No.: 19/282,294

(22) Filed: Jul. 28, 2025

(30) Foreign Application Priority Data
Jul. 31, 2024 (JP) 2024-125492

(51) Int. Cl. G06Q 30/0601

(52) U.S. Cl. CPC G06Q 30/06212

(57) ABSTRACT

A server device includes an acceptor, an extractor, a calculator, and an outputter. The acceptor causes a terminal to display a form that includes a plurality of input fields to which parameter values of a plurality of parameters to be registered in a database in association with a product are input, and accepts input of each of the parameter values. The extractor extracts, from the database, another product associated with a parameter value identical or similar to a specific value input to a specific input field. The plurality of parameters includes a selection parameter that requires input to at least one of a plurality of parameter items. The calculator calculates a usage frequency at which each of the plurality of parameter items of the extracted other product is used. The outputter outputs the calculated usage frequency of each of the plurality of parameter items.

### CROSS-REFERENCE TO RELATED APPLICATIONS

This application claims the benefit of Japanese Patent Application No. 2024-125492, filed on Jul. 31, 2024, the entire disclosure of which is incorporated by reference herein.

### FIELD OF THE INVENTION

The present disclosure relates to a server device for supporting input of product information, an input support method, and a recording medium.

### BACKGROUND OF THE INVENTION

In systems for electronic commerce, such as online shopping, product information of each product to be traded is registered.

In order to reduce time and effort required to input the product information, for example, Japanese Patent Application Publication No. 2007-226539 discloses a data management device that refers to the product information of each registered product, determines whether a product to be registered constitutes a set with other products, and calculates a price discount for each product determined to constitute a set.

### SUMMARY OF THE INVENTION

The product information may include a parameter requiring input to at least one of a plurality of selection items. For example, when a product to be registered is food, a parameter for the amount of content generally requires input to at least one selection item among the number of units, the weight, and the volume.

However, in certain cases, it is difficult for a store or a staff member thereof to determine which of the plurality of selection items is required to be filled. In particular, in a case of a set product composed of identical products, it is often unclear for the store or the staff member thereof which of the number of units, the weight, and the volume is important information for a shopper. In such a case, there has been a problem in that appropriate information is not input and the shopper is thus not presented with necessary information.

The present disclosure is made with the view of the above situation, and an objective of the present disclosure is to provide a server device, an input support method, and a recording medium capable of supporting input of product information including a plurality of selection items.

In order to solve the above problem, a server device according to the present disclosure includes:
one or more processors to
   cause a terminal to display a form including a plurality of input fields to which parameter values of a plurality of parameters to be registered in a database in association with a product to be traded are input, and accept input of each of the parameter values,
   extract, from the database, another product associated with a parameter value identical or similar to a specific value input to a specific input field of the plurality of input fields,
   calculate a usage frequency at which each of a plurality of parameter items of the extracted other product is used, the plurality of parameters including a selection parameter requiring input to at least one parameter item of the plurality of parameter items, and
   output the calculated usage frequency of each of the plurality of parameter items.

The present disclosure can provide a server device, an input support method, and a recording medium capable of supporting input of product information including a plurality of selection items.

### BRIEF DESCRIPTION OF DRAWINGS

FIG. 1 illustrates an overall configuration of an input support system according to an embodiment;

FIG. 2 illustrates an example of a registration form displayed on a terminal;

FIG. 3 illustrates an example of the registration form to which a product name and a category are input;

FIG. 4 illustrates an example of the registration form to which a calculation result is output;

FIG. 5 is an explanatory diagram illustrating a functional configuration of a server device;

FIG. 6 illustrates an example of a product information list stored in a database illustrated in FIG. 5;

FIG. 7 is an explanatory diagram illustrating a physical configuration of the server device;

FIG. 8 is a flowchart of input support processing performed by the server device;

FIG. 9 illustrates another example of the registration form displayed on the terminal;

FIG. 10 illustrates an example of the calculation result output by an outputter illustrated in FIG. 5;

FIG. 11 illustrates another example of the calculation result output by the outputter illustrated in FIG. 5;

FIG. 12 illustrates an example of distribution information output by the outputter illustrated in FIG. 5; and

FIG. 13 illustrates an example of a display history stored in a database according to a modified example.

### DETAILED DESCRIPTION OF THE INVENTION

Hereinafter, an embodiment of the present disclosure is described in detail with reference to the drawings. The same or corresponding parts in the drawings are designated by the same reference signs. Note that the present embodiment is intended for description and is not intended to limit the scope of the present disclosure. Accordingly, it is possible for persons skilled in the art to employ an embodiment in which part or all of the elements of the embodiment are replaced by equivalents thereof, which are also included in the scope of the present disclosure.

### Overall Configuration

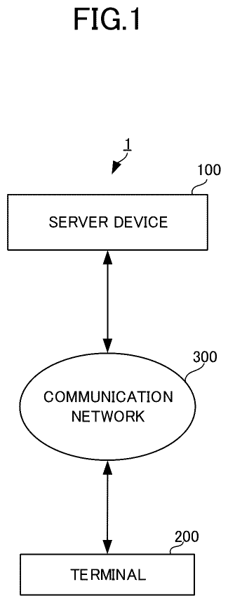

FIG. 1 is a schematic diagram illustrating a configuration of an input support system 1 according to the embodiment of the present disclosure. As illustrated in FIG. 1, the input support system 1 includes a server device 100 and a terminal 200. The server device 100 and the terminal 200 are connected to each other via a communication network 300.

The input support system 1 is a system for supporting input of product information that requires input to at least one of a plurality of selection items (hereinafter, referred to as parameter items) when a store registers, in a database, the product information of a product to be sold on an electronic market. In the following description, an example is described of a case where products to be traded on the electronic market include food, appliances, clothing, household goods, and furniture. The input support system 1 may be a system for supporting input of information of services such as travel, restaurants, or beauty salons on a reservation site or trading targets on a financial product provision site.

The server device 100 includes one or a plurality of server computers. The server device 100 is operated by a provider or the like providing an electronic commerce service, such as an online mall, an online shopping site, an auction site, or a flea market site.

The server device 100 includes the database, manages the product information of each of various products being sold by the store, and supports input of the product information of a newly-sold product when displaying this product. Specifically, when inputting the product information including the plurality of parameter items, the server device 100 extracts, from the database, a similar product that is similar to the product to be registered, and outputs, to the terminal 200, a usage frequency at which each of the parameter items is used.

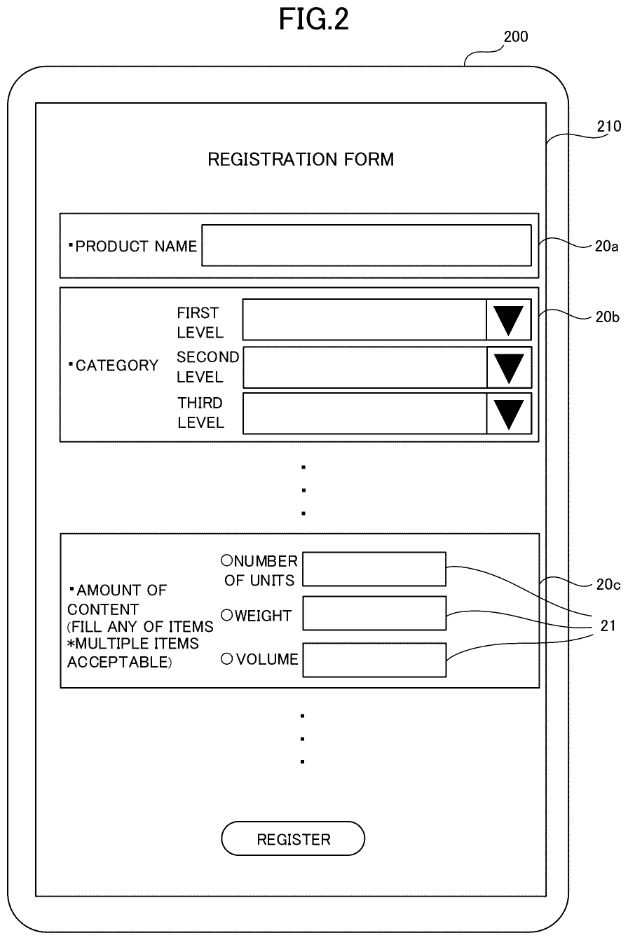

The server device 100 causes the terminal 200 to display a registration form that accepts input of the product information. Here, an example of the registration form is illustrated in FIG. 2. As illustrated in FIG. 2, a registration form 210 includes a plurality of input fields 20a, 20b, 20c . . . to which parameters for the product name, the category, and the amount of content are input. Hereinafter, the input fields 20a, 20b, 20c . . . are also collectively referred to as input fields 20.

The parameter for the amount of content is a selection parameter that requires input to at least one of the plurality of parameter items that are the number of units, the weight, and the volume. The input field 20c of the amount of content includes input fields 21 that accept input of parameter values of the number of units, the weight, and the volume. The selection parameter is not limited to the parameter for the amount of content, and may be any parameter including a plurality of parameter items.

When the parameter values are input to the input fields 20a and 20b of the product name and the category, which are predetermined setting parameters, the server device 100 extracts, from the database, as the similar product, another product to which parameter values identical or similar to the input parameter values are set.

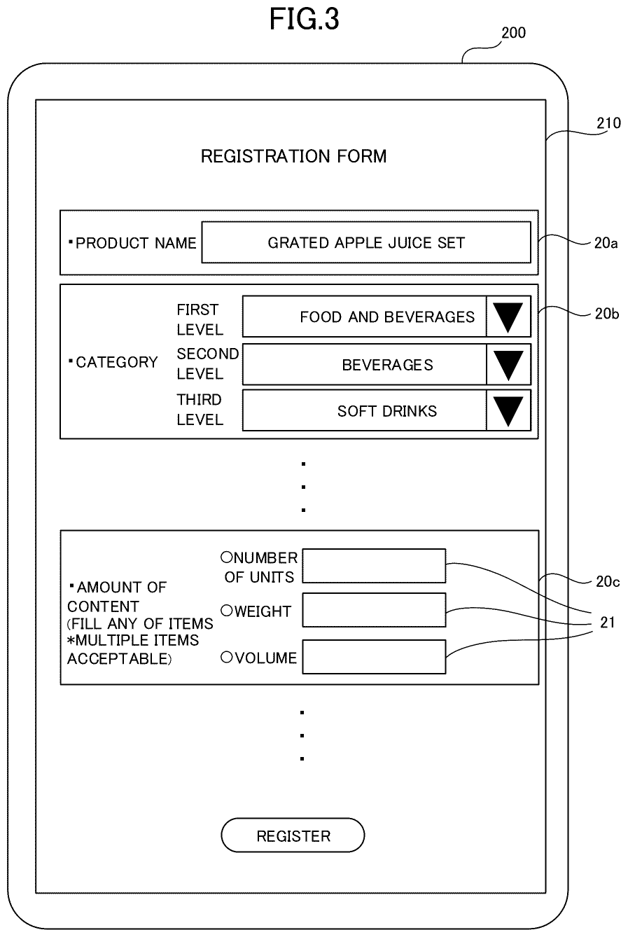

Here, an example of the registration form 210 to which the product name and the category are input is illustrated in FIG. 3. As illustrated in FIG. 3, when the product name “Grated Apple Juice Set”, a first-level category “Food and Beverages”, a second-level category “Beverages”, and a third-level category “Soft Drinks” are input to the input fields 20a and 20b, the server device 100 extracts, from the database, as the similar product, another product to which parameter values identical or similar to those of the input product name and categories are set. Similar categories may mean that all of the first to third-level categories are identical or similar, or may mean that only the first-level categories are identical or similar. The server device 100 calculates, with reference to the database, the usage frequency at which each of the parameter items “Number of Units”, “Weight”, and “Volume” in the selection parameter “Amount of Content” of the extracted similar product is used, and causes the calculation result to be displayed in the registration form 210.

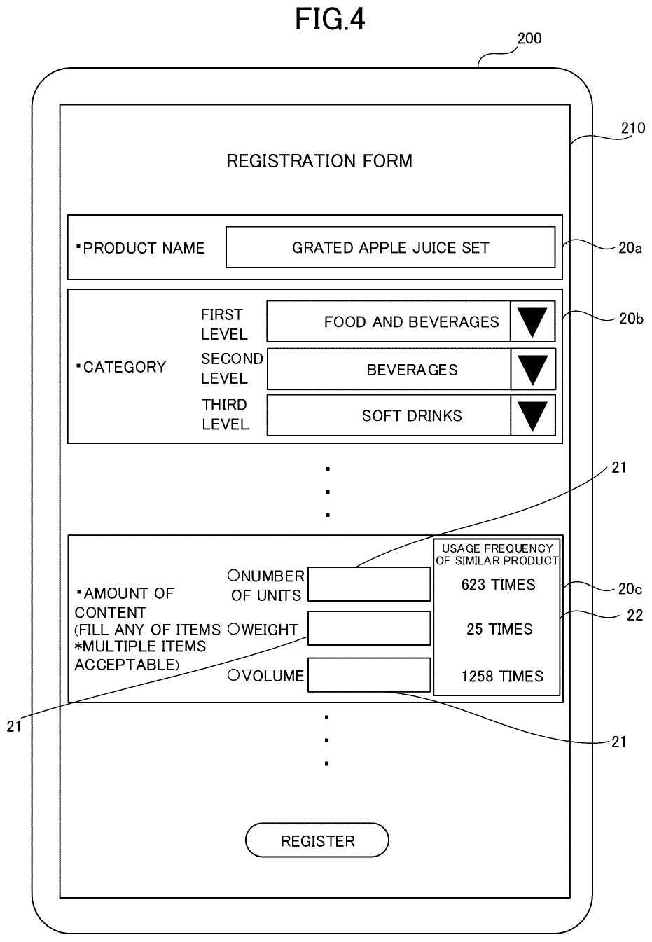

Here, an example of the registration form 210 in which the calculation result is displayed is illustrated in FIG. 4. As illustrated in FIG. 4, a calculation result 22, which is the number of times each of the parameter items of the similar product is used, is disposed in the vicinity of the right side of the input fields 21 of the number of units, the weight, and the volume, and is displayed on a display screen of the terminal 200. This allows a staff member of the store to determine, based on the usage frequency of each of the parameter items of another product, which parameter item of the number of units, the weight, and the volume is to be filled with the parameter value.

Returning back to FIG. 1, the terminal 200 is an information terminal (a so-called computer) used by the staff member of the store that sells products on the electronic market, such as a smartphone, a tablet, and a personal computer (PC), and is capable of mutually communicating with the server device 100 via the communication network 300. For example, a store management application for managing the store on the electronic market is installed in the terminal 200. The staff member of the store starts the store management application to check sales or order details, register and edit the product information, and respond to inquiries from shoppers.

The communication network 300 may include various types of networks. Examples thereof include a local area network (LAN), a wide area network (WAN) such as the Internet, a telecommunication network such as a public switched telephone network (PSTN), a wireless network, a public switched network, a satellite network, a cellular network, a public land mobile network (PLMN), a metropolitan area network (MAN), a private network, an ad hoc network, an intranet, a fiber optic-based network, and a combination of the above or other types of networks.

### Functional Configuration of Server Device

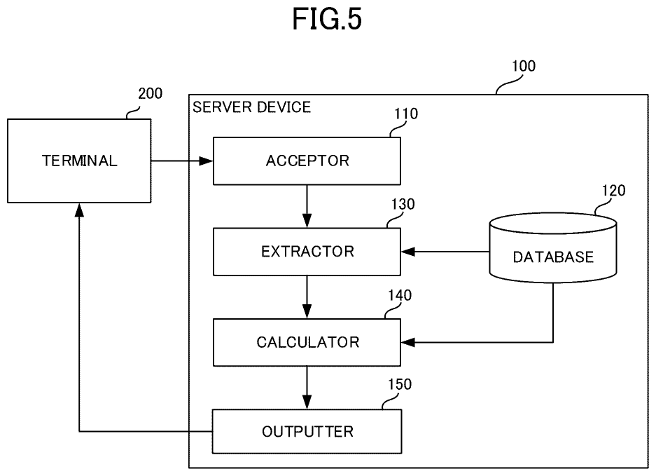

Next, a functional configuration of the server device 100 is described using FIG. 5. The server device 100 includes an acceptor 110, a database 120, an extractor 130, a calculator 140, and an outputter 150.

The acceptor 110 accepts input of the product information. Specifically, the acceptor 110 causes the terminal 200 to display the registration form 210 illustrated in FIG. 2, and accepts input of the parameter values to the input fields 20. When the parameter values are input to the input fields 20, the terminal 200 transmits the input parameter values to the server device 100.

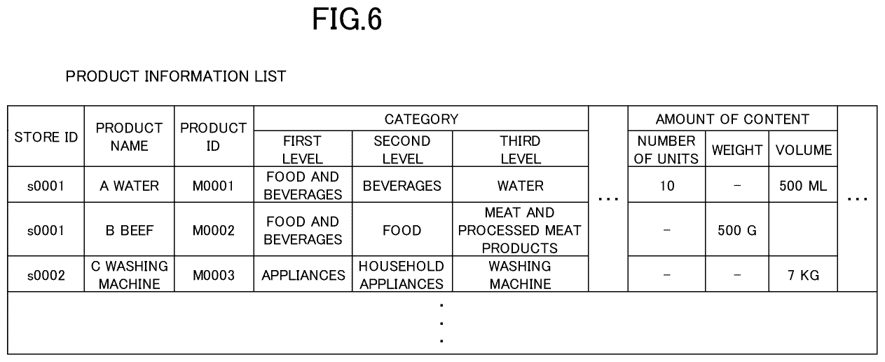

The database 120 is a database in which a product information list, which indicates the product information of each product to be traded on the electronic market, is stored. Here, an example of the product information list is illustrated in FIG. 6. As illustrated in FIG. 6, the product information list includes parameters such as “Store Identification (ID)” that is information for uniquely identifying a store, “Product Name” that indicates the name of each product, “Product ID” that is information for uniquely identifying each product, “Category” that indicates a category for classifying each product, and “Amount of Content” that includes the number of units, the weight, and the volume of each product.

The parameters included in the product information list are not limited thereto, and the product information list may include any parameters such as a sales price, a shipping fee, a delivery method, a sales period, the number of inventory, delivery time information, and a type of set of each product. The hierarchical structure of the category is not limited to that composed of three levels, and may be composed of any number of levels. Moreover, the number of levels may be different for each product.

Returning back to FIG. 5, the extractor 130 extracts, as the similar product, another product associated with parameters with parameter values identical or similar to the parameter values input to the specific input fields 20 in the registration form 210. Specifically, the extractor 130 extracts, with reference to the product information list illustrated in FIG. 6, as the similar product, another products associated with parameters with parameter values identical or similar to the parameter values input to the input fields 20 of the product name and the category, which are the predetermined setting parameters. Processing of the extractor 130 is described later in detail.

The extractor 130 may extract the similar product based on either of the product name and the category. Specifically, the extractor 130 may extract, as the similar product, another product with an identical or similar product name, or another product with an identical or similar category.

The calculator 140 calculates the usage frequency at which each of the parameter items in the selection parameter of the similar product extracted by the extractor 130 is used. Specifically, the calculator 140 calculates, with reference to the product information list illustrated in FIG. 6, the usage frequency of each of the parameter items “Number of Units”, “Weight”, and “Volume” of the similar product extracted by the extractor 130. Processing of the calculator 140 is described later in detail.

The outputter 150 outputs, to the terminal 200, the usage frequency of each of the parameter items calculated by the calculator 140. Specifically, the outputter 150 causes the usage frequency of each of the parameter items to be displayed in the registration form 210 displayed by the terminal 200. As illustrated in FIG. 4, the outputter 150 causes the calculation result 22 calculated by the calculator 140 to be displayed in the vicinity of the right side of the input fields 21 to which the parameter values of the parameter items “Number of Units”, “Weight”, and “Volume” in the selection parameter “Amount of Content” are input.

### Physical Configuration of Information Processing Device

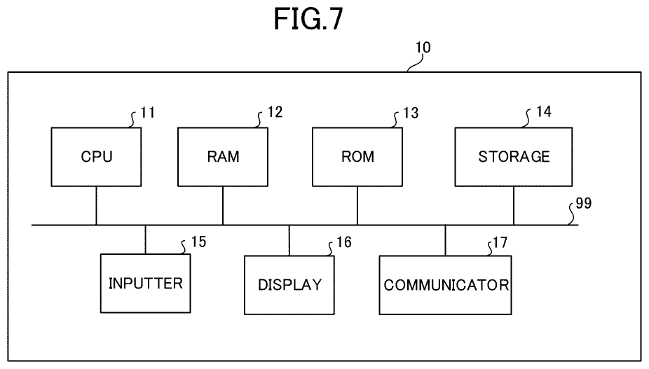

FIG. 7 is a block diagram illustrating a hardware configuration of an information processing device 10 by which the server device 100 and the terminal 200 are achieved. As illustrated in FIG. 7, the information processing device 10 physically includes a central processing unit (CPU) 11 that performs processing according to a program, a random access memory (RAM) 12 that is a volatile memory, a read only memory (ROM) 13 that is a non-volatile memory, a storage 14 that stores data, an inputter 15 that accepts input of information, a display 16 that displays information visually, and a communicator 17 that transmits and receives information, which are connected via an internal bus 99.

The CPU 11 performs various types of processing by reading a program stored in the storage 14 into the RAM 12 and executing the program. The CPU 11 performs, as main functions provided by the program, processing of each of the acceptor 110, the extractor 130, the calculator 140, and the outputter 150.

The RAM 12 is used as a work area for the CPU 11. The ROM 13 stores a control program to be executed by the CPU 11 for a basic operation of the server device 100, a basic input/output system (BIOS), and the like.

The storage 14 includes a hard disk drive, stores a program to be executed by the CPU 11, and stores various types of data to be used in execution of the program. The storage 14 functions as the database 120.

The inputter 15 is a user interface including a keyboard, a mouse, a communication device, and the like. The display 16 is a display device displaying information visually, such as a liquid crystal display or an organic electro luminescence (EL) display.

The communicator 17 is a network termination device or a wireless communication device connected to a network, and a serial interface or a local area network (LAN) interface connected to the network termination device or the wireless communication device. The communicator 17 functions as the acceptor 110 and the outputter 150.

### Input Support Processing

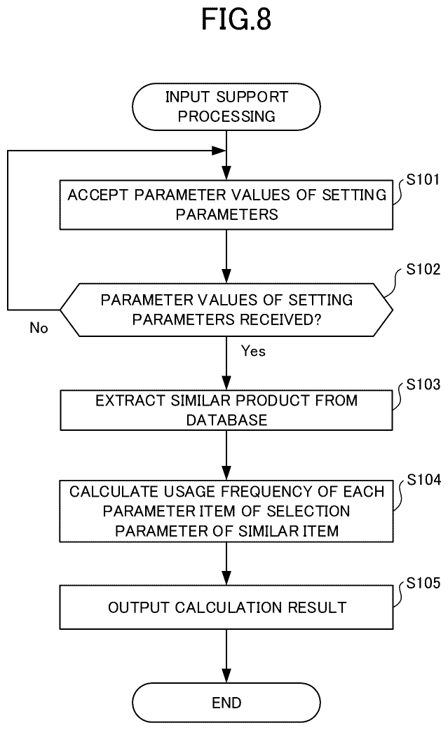

Next, an operation of the server device 100 is described with reference to FIG. 8. When displaying a new product on the electronic market, the staff member of the store operates the terminal 200 to start the store management application that is pre-installed in the terminal 200. For example, when a menu for displaying a new product is selected in a menu screen of the store management application, the server device 100 transmits, to the terminal 200, the registration form 210 for registering the product information illustrated in FIG. 2, and starts input support processing.

The acceptor 110 accepts the parameter values of the predetermined setting parameters (step S101). Specifically, the terminal 200 accepts, in the registration form 210 transmitted from the server device 100 and illustrated in FIG. 2, input of the parameter values of the product name and the category that are the setting parameters. As illustrated in FIG. 3, when the parameter value “Grated Apple Juice Set” is input to the input field 20a of the product name and the parameter values “Food and Beverages”, “Beverages”, and “Soft Drinks” are input to the input field 20b of the category, the terminal 200 transmits each of the input parameter values to the server device 100.

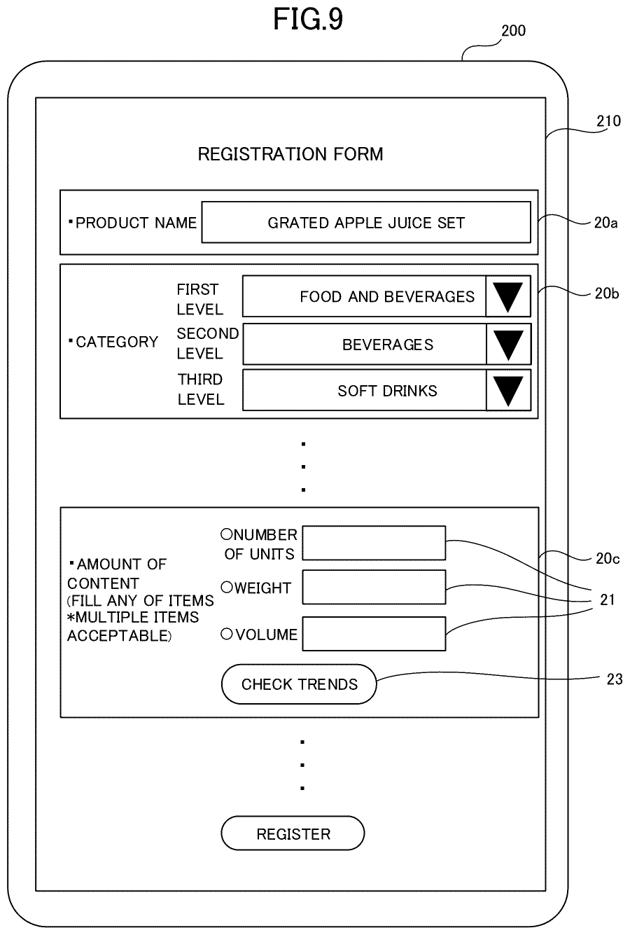

While the parameter values are input to the input fields 20a and 20b, the terminal 200 may transmit the parameter values to the server device 100 in the background, and as illustrated in FIG. 9 that illustrates another example of the registration form 210, when the parameter values are input to the input fields 20a and 20b and a button 23 for instructing check of the usage frequency of another product is tapped, the terminal 200 may transmit, to the server device 100, the parameter values input to the input fields 20a and 20b.

Next, the acceptor 110 determines whether the parameter values of the setting parameters have been received (step S102). When the acceptor 110 determines that the parameter values of “Product Name” and “Category” have been received (Yes in step S102), the acceptor 110 proceeds to step S103. When the acceptor 110 determines that no parameter values of “Product Name” and “Category” have been received (No in step S102), the acceptor 110 returns back to step S101 and accepts the parameter values of the setting parameters.

In step S103, the extractor 130 extracts, from the database 120, the similar product to which parameter values identical or similar to those of the setting parameters received in step S102 are set (step S103). Specifically, the extractor 130 extracts, with reference to the product information list illustrated in FIG. 6, as the similar product, another product to which parameter values identical or similar to those of the product name “Grated Apple Juice Set” and the categories “Food and Beverages”, “Beverages”, and “Soft Drinks” received in step S102 are set.

As an example of a method for extracting another product with an identical or similar product name, the extractor 130 calculates the degree of similarity of the product name by calculating an edit distance, such as the Levenshtein distance or the Jarro-Winkler distance, between the product name of a product to be registered and the product name of a product already registered in the database 120. The extractor 130 determines that another product with a higher degree of similarity to the product name of the product to be registered than a threshold has an identical or similar product name.

As an example of a method for extracting another products with an identical or similar category, the extractor 130 determines a product with an identical third-level category, which is the lowest-level category, to be another product with an identical category, and determines a product with a different third-level category and an identical second-level category, which is one level higher than the third-level category, to be another product with a similar category.

Next, the calculator 140 calculates the usage frequency of each of the parameter items in the selection parameter of the similar product extracted in step S103 (step S104). Specifically, the extractor 160 acquires, with reference to the product information list illustrated in FIG. 6, a registration status of each of the parameter items “Number of Units”, “Weight”, and “Volume” of the similar product extracted in step S103, and calculates the usage frequency of each of the parameter items by counting the number of registrations of each of the parameter items.

Next, the outputter 150 outputs the calculation result 22 calculated by the calculator 140 (step S105). Specifically, the outputter 150 causes the usage frequency of each of the parameter items to be displayed in the registration form 210 displayed by the terminal 200. As illustrated in FIG. 4, the outputter 150 causes the calculation result 22, which includes the number of times each of the parameter items is used, to be displayed on the right side of the input fields 21 to which the parameter values of the parameter items “Number of Units”, “Weight”, and “Volume” in the selection parameter “Amount of Content” are input, and ends the input support processing.

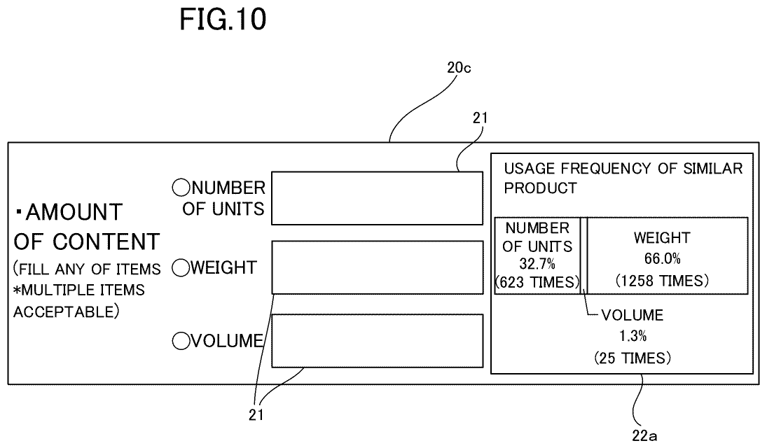

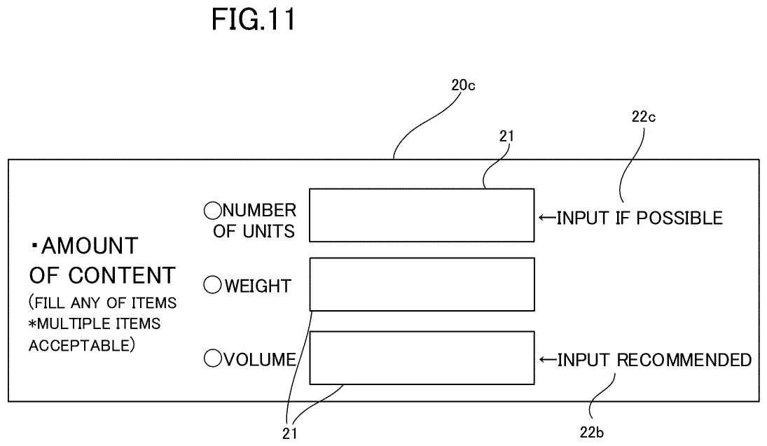

A method for displaying the calculation result 22 calculated by the outputter 150 is not limited to displaying the number of times each of the parameter items is used. Here, another example of the method for displaying the usage frequency is illustrated in FIGS. 10 and 11. As illustrated in FIG. 10, the outputter 150 may causes a calculation result 22a, which indicates, in a band graph, the number of times and percentage of use of each of the parameter items, to be displayed. The graph is not limited to the band graph, and may be any graph, such as a bar graph, a pie graph, or a line graph.

The outputter 150 may also cause a character string representing the degree of recommendation of input to each of the parameter items to be displayed based on the calculated usage frequency. As illustrated in FIG. 11, the outputter 150 may determine that the parameter item “Volume”, which is the most frequently used parameter item, is most recommended to be filled, cause a character string 22b “Input recommended” to be displayed in the vicinity of the input field 21 of “Volume”, and cause a character string 22c “Input if possible” to be displayed in the vicinity of the input field 21 of “Number of Units”, which is the second most frequently used parameter item, to present which of the parameter items is recommended to be filled. Which of the parameter items is recommended to be filled may be determined by, for example, determining whether the usage frequency of each of the parameter items is a threshold percentage or more. The representation of the degree of recommendation is not limited to the character string, and may be an icon or the like.

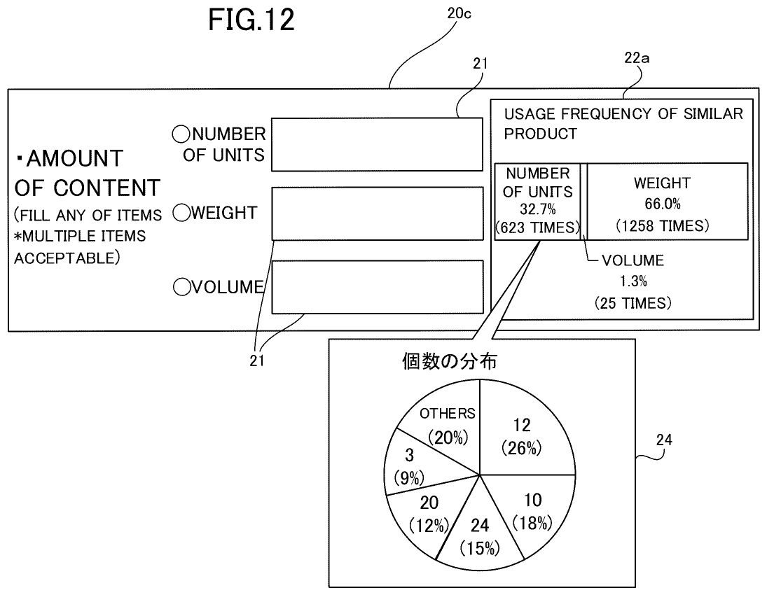

The outputter 150 may further cause the distribution of the parameter values of each of the parameter items of the similar product to be displayed. Here, an example of the distribution of the parameter values of each of the parameter items displayed by the outputter 150 is illustrated in FIG. 12. As illustrated in FIG. 12, in the band graph included in the calculation result 22a output by the outputter 150, for example, when a portion of the number of units in the graph is selected, the outputter 150 generates a pie graph indicating the distribution of the parameter values of the number of units, and causes distribution information 24, which includes the generated distribution, to be displayed below the calculation result 22a. For example, when registering a set of ten bottles of 500 ml beverages, it is difficult in certain cases for the staff member of the store to determine whether to input the volume “500 ml” and the number of units “10”, or input the volume “5,000 ml” and the number of units “1”. Reference to the distribution information 24 illustrated in FIG. 12 allows the staff member of the store to determine that it is preferable to input the volume “500 ml” and the number of units “10” based on a high percentage of the parameter item “Number of units” of the similar product that is a plural, such as “12”, “10”, or “24”.

As described above, the server device 100 extracts, from the database 120, the similar product that is similar to a product to be registered, and outputs, to the terminal 200, the usage frequency of each of the parameter items in the selection parameter of the extracted similar product. Therefore, when displaying a new product, the staff member of the store can learn which of the parameter items of the similar product is used. For example, the staff member of the store can determine, with reference to the calculation result 22 displayed in the registration form 210 illustrated in FIG. 4, that at least the parameter item “Volume” is required to be filled, the parameter item “Number of Units” is required to be filled if possible, and the parameter item “Weight” is not required to be filled, and determine to input the parameter values to the parameter items “Volume” and “Number of Units”.

### Modification Example

In the above embodiment, a configuration is described in which the calculator 140 calculates the usage frequency of each of the parameter items by referring to the product information list illustrated in FIG. 6 to count the number of registrations of each of the parameter items of the similar product. However, the present disclosure is not limited thereto. For example, the calculator 140 may refer to a display history of a sales page of the similar product displayed on a user terminal of a shopper using an electronic commerce service, and calculate the number of times each of the parameter items has been used as a search keyword in searches leading to the above sales page to be used as the usage frequency. In such a configuration, the database 120 may store a display history in which a product ID of a product corresponding to the sales page displayed on the user terminal is associated with the search keyword.

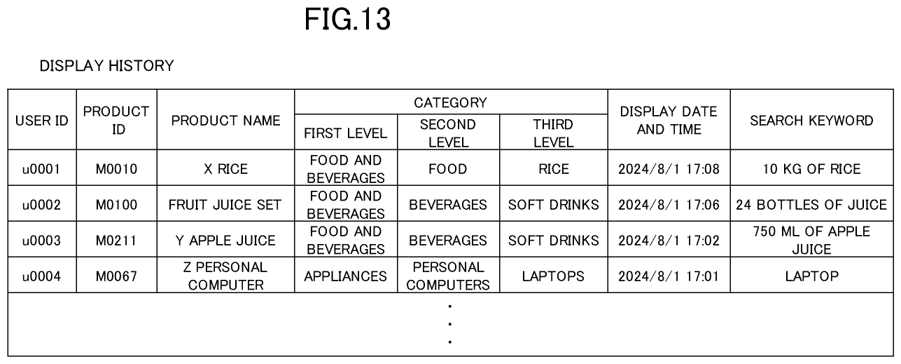

Here, an example of the display history stored in the database 120 is illustrated in FIG. 13. As illustrated in FIG. 13, the display history includes information such as “User ID” that is information for uniquely identifying a shopper, “Product ID” that is information for uniquely identifying a product corresponding to a sales page displayed on the user terminal, “Product Name” that indicates the name of the product, “Category” that indicates the category of the product, “Display Date and Time” that indicates the date and time at which the sales page has been displayed, and “Search Keyword” that indicates a search keyword that has led to display of the sales page.

For example, when calculating, with reference to the display history illustrated in FIG. 13, the usage frequency of each of the parameter items “Number of Units”, “Weight”, and “Volume” in the selection parameter “Amount of Content” as described above, the calculator 140 acquires the search keyword for the similar products extracted in step S103 (for example, “Fruit Juice Set” and “Y Apple Juice”), extracts a unit expression from the search keywords, and determines which of the parameter items “Number of Units”, “Weight”, and “Volume” the search keyword corresponds to. When the search keyword includes a unit expression such as “unit” or “bottle”, the calculator 140 adds +1 to the count of “Number of Units”. When the search keyword includes a unit expression such as “gram (g)” or “kilogram (kg),” the calculator 140 adds +1 to the count of “Weight”. When the search keyword includes a unit expression such as “milliliter (ml)” or “liter (l),” the calculator 140 adds +1 to the count of “Volume”. Then, the calculator 140 calculates the number of registrations of each of the parameter items as the usage frequency. The calculator 140 may add +1 to the count even when the search keyword includes the name of a parameter item, such as “Number of Units”, “Weight”, or “Volume”.

In the above embodiment, a configuration is described in which the server device 100 includes the database 120. However, the present disclosure is not limited thereto. Information stored in the storage 14 may be collectively managed by a cloud server existing on a network, and the search device 100 may access the cloud server and perform reading and writing of the information as needed. In such a configuration, the search device 100 does not have to include the database 120. Moreover, the input support processing performed by the server device 100 may be performed on a cloud based on the information stored in the cloud server.

The server device 100 according to the above embodiment is implementable using a general computer instead of a dedicated device. For example, the server device 100 that performs one of the above types of processing may be configured by installing, from a recording medium storing a program to cause the computer to perform the above processing, the program in the computer. In addition, the server device 100 may be configured by a plurality of computers operating in collaboration with one another.

When the above functions are achieved by sharing of operation between an operating system (OS) and an application or by cooperation between the OS and the application, only a part other than the OS may be stored in the medium.

In addition, it is possible to superimpose programs on a carrier wave and distribute the programs via a communication network. For example, the programs may be distributed through an application store (an app store), or the programs may be posted on a bulletin board system (BBS) on the communication network and distributed via the network. Then, these programs may be configured to execute the above processing by starting and executing the programs in a manner similar to other application programs under the control of the OS.

The various aspects of the present disclosure are described as Appendices.

### APPENDIX 1

A server device comprising:
one or more processors to
   cause a terminal to display a form including a plurality of input fields to which parameter values of a plurality of parameters to be registered in a database in association with a product to be traded are input, and accept input of each of the parameter values,
   extract, from the database, another product associated with a parameter value identical or similar to a specific value input to a specific input field of the plurality of input fields,
   calculate a usage frequency at which each of a plurality of parameter items of the extracted other product is used, the plurality of parameters including a selection parameter requiring input to at least one parameter item of the plurality of parameter items, and
   output the calculated usage frequency of each of the plurality of parameter items.

### APPENDIX 2

The server device according to appendix 1, wherein
the one or more processors extract another product registered in the database in association with a parameter value identical or similar to the specific value input to the specific input field to which a product name or a category is input.

### APPENDIX 3

The server device according to appendix 1 or 2, wherein
the one or more processors calculate the usage frequency by referring to the database to calculate a number of registrations of each of the plurality of parameter items of the extracted other product or a percentage of the number of registrations of each of the plurality of parameter items to a total number of registrations of the plurality of parameter items.

### APPENDIX 4

The server device according to appendix 1 or 2, wherein
the one or more processors calculate the usage frequency by calculating a number of times each of the plurality of parameter items is used as an input search keyword in a history leading to display of a sales page of the extracted other product.

### APPENDIX 5

The server device according to any one of appendixes 1 to 4, wherein
the one or more processors cause the usage frequency of each of the plurality of parameter items to be displayed in a vicinity of each of the plurality of input fields to which the parameter values of the plurality of parameter items are input.

### APPENDIX 6

The server device according to any one of appendixes 1 to 5, wherein
the one or more processors indicate the usage frequency of each of the plurality of parameter items in one of a bar graph, a band graph, a pie graph, or a line graph.

### APPENDIX 7

The server device according to any one of appendixes 1 to 5, wherein
the one or more processors cause, based on the usage frequency of each of the plurality of parameter items, a character string or an icon representing a degree of recommendation of input to be displayed in a vicinity of each of the plurality of input fields to which the parameter values of the plurality of parameter items are input.

### APPENDIX 8

The server device according to any one of appendixes 1 to 7, wherein
the one or more processors further output a distribution of the parameter values of the plurality of parameter items.

### APPENDIX 9

The server device according to any one of appendixes 1 to 8, wherein
the selection parameter is an amount of content, and
the plurality of parameter items include a number of units, a weight, and a volume.

### APPENDIX 10

An input support method comprising:
causing, by a computer, a terminal to display a form including a plurality of input fields to which parameter values of a plurality of parameters to be registered in a database in association with a product to be traded are input, and accepting, by the computer, input of each of the parameter values;
extracting, by the computer, from the database, another product associated with a parameter value identical or similar to a specific value input to a specific input field of the plurality of input fields;
calculating, by the computer, a usage frequency at which each of a plurality of parameter items of the extracted other product is used, the plurality of parameters including a selection parameter requiring input to at least one parameter item of the plurality of parameter items; and
outputting, by the computer, the calculated usage frequency of each of the plurality of parameter items.

### APPENDIX 11

A computer-readable recording medium storing a program, the program causing a computer to perform operations comprising:
causing a terminal to display a form including a plurality of input fields to which parameter values of a plurality of parameters to be registered in a database in association with a product to be traded are input, and accepting input of each of the parameter values;
extracting, from the database, another product associated with a parameter value identical or similar to a specific value input to a specific input field of the plurality of input fields;
calculating a usage frequency at which each of a plurality of parameter items of the extracted other product is used, the plurality of parameters including a selection parameter requiring input to at least one parameter item of the plurality of parameter items; and
outputting the calculated usage frequency of each of the plurality of parameter items.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

The present disclosure can provide a server device, an input support method, and a recording medium capable of supporting input of product information including a plurality of selection items.

1. A server device comprising:
one or more processors to
cause a terminal to display a form including a plurality of input fields to which parameter values of a plurality of parameters to be registered in a database in association with a product to be traded are input, and accept input of each of the parameter values,
extract, from the database, another product associated with a parameter value identical or similar to a specific value input to a specific input field of the plurality of input fields,
calculate a usage frequency at which each of a plurality of parameter items of the extracted other product is used, the plurality of parameters including a selection parameter requiring input to at least one parameter item of the plurality of parameter items, and
output the calculated usage frequency of each of the plurality of parameter items.

2. The server device according to claim 1, wherein
the one or more processors extract another product registered in the database in association with a parameter value identical or similar to the specific value input to the specific input field to which a product name or a category is input.

3. The server device according to claim 1, wherein
the one or more processors calculate the usage frequency by referring to the database to calculate a number of registrations of each of the plurality of parameter items of the extracted other product or a percentage of the number of registrations of each of the plurality of parameter items to a total number of registrations of the plurality of parameter items.

4. The server device according to claim 1, wherein
the one or more processors calculate the usage frequency by calculating a number of times each of the plurality of parameter items is used as an input search keyword in a history leading to display of a sales page of the extracted other product.

5. The server device according to claim 1, wherein
the one or more processors cause the usage frequency of each of the plurality of parameter items to be displayed in a vicinity of each of the plurality of input fields to which the parameter values of the plurality of parameter items are input.

6. The server device according to claim 1, wherein
the one or more processors indicate the usage frequency of each of the plurality of parameter items in one of a bar graph, a band graph, a pie graph, or a line graph.

7. The server device according to claim 1, wherein
the one or more processors cause, based on the usage frequency of each of the plurality of parameter items, a character string or an icon representing a degree of recommendation of input to be displayed in a vicinity of each of the plurality of input fields to which the parameter values of the plurality of parameter items are input.

8. The server device according to claim 1, wherein
the one or more processors further output a distribution of the parameter values of the plurality of parameter items.

9. The server device according to claim 1, wherein
the selection parameter is an amount of content, and
the plurality of parameter items include a number of units, a weight, and a volume.

10. An input support method comprising:
causing, by a computer, a terminal to display a form including a plurality of input fields to which parameter values of a plurality of parameters to be registered in a database in association with a product to be traded are input, and accepting, by the computer, input of each of the parameter values;
extracting, by the computer, from the database, another product associated with a parameter value identical or similar to a specific value input to a specific input field of the plurality of input fields;
calculating, by the computer, a usage frequency at which each of a plurality of parameter items of the extracted other product is used, the plurality of parameters including a selection parameter requiring input to at least one parameter item of the plurality of parameter items; and
outputting, by the computer, the calculated usage frequency of each of the plurality of parameter items.

11. A computer-readable recording medium storing a program, the program causing a computer to perform operations comprising:
causing a terminal to display a form including a plurality of input fields to which parameter values of a plurality of parameters to be registered in a database in association with a product to be traded are input, and accepting input of each of the parameter values;
extracting, from the database, another product associated with a parameter value identical or similar to a specific value input to a specific input field of the plurality of input fields;
calculating a usage frequency at which each of a plurality of parameter items of the extracted other product is used, the plurality of parameters including a selection parameter requiring input to at least one parameter item of the plurality of parameter items; and
outputting the calculated usage frequency of each of the plurality of parameter items.
